(19) United States
(12) Patent Application Publication
(10) Pub. No.: US 2012/0012510 A1
(43) Pub. Date: Jan. 19, 2012

(54) FILTER AND FILTER ASSEMBLY

(76) Inventor: Gianni Ventura, Figtree (AU)

(21) Appl. No.: 13/183,502

(22) Filed: Jul. 15, 2011

(30) Foreign Application Priority Data
Jul. 15, 2010 (AU) 2010903147

(51) Int. Cl. B01D 35/02; B23P 11/00; B23P 17/00; E03C 1/264

(52) U.S. Cl. 210/164; 210/163; 29/428; 29/525.01

(57) ABSTRACT

A filter assembly for a floor drain for use in indoor drains such as in drains in showers, baths, sinks or floors is disclosed. The filter assembly 10 comprising a hollow filter basket 13 having a base wall 16 and a side wall 17 extending from said base wall 16. The side wall 16 having a plurality of slots or openings 12 through which water may pass, and said base wall 16 being of a conical form and having a plurality of openings 26 therein.

### TECHNICAL FIELD

This invention relates to a filter and a filter assembly and in particular to a filter and a filter assembly for use in indoor drains such as in drains in showers, baths, sinks or floors.

### BACKGROUND ART

Showers are conventionally provided with a floor drain through which water is drained from the shower into the plumbing system for passage to waste. Such drains typically include a perforated or grid-like strainer through which liquid flows into the drain for flow to waste however the strainers which are employed have openings of such a size that solid materials particularly hair and skin still pass from the shower recess through the strainer and thus into the drain. This can cause blockages in the drain causing possible internal flooding. Alternatively the plumbing system can become blocked necessitating cleaning or unblocking by skilled persons such as plumbers. This can be expensive particularly if the blockages occur in locations where excavations are required to be carried out to gain access to the plumbing system where blockages have occurred. Similar problems can be encountered with drains which are used in baths, sinks, basins or simply in floors.

Clearly it would be advantageous of the present invention to provide a filter and a filter assembly for use with a drain of a shower, bath, basin, floor or other location from which liquid, typically grey water is to be drained which overcomes or at least ameliorates the disadvantages set forth above.

### SUMMARY OF THE INVENTION

The present invention aims to provide a filter and a filter assembly for use with drains to reduce the possibility of blockages in the drain or plumbing system associated with the drain.

The present invention thus provides in one preferred aspect a filter for a floor drain, said filter comprising a hollow filter basket having a base wall and a side wall extending from said base wall, said side wall having a plurality of slots or openings through which water may pass, and said base wall being of a conical form and having a plurality of openings therein.

The term “floor drain” as used throughout the specification and claims includes a drain in the floor or base of a shower, bath, basin, floor or any other drain for draining liquid, typically grey water from a particular area.

The slots or openings in the side wall may comprise an upper set of slots or openings and a lower set of slots or openings. Preferably the slots are slots which extend generally longitudinally of the filter basket. The slots in the upper set of slots are preferably of a greater cross sectional area or greater width than the slots in the lower set of slots. Thus if the lower set of slots tend to become blocked or partly blocked, liquid can still flow through the filter basket by passing through the slots of the upper set.

The filter basket may be of a generally cup shaped configuration. Preferably the filter basket has a lower frustoconical outer wall portion containing the first set of slots and an upper frustoconical outer wall portion containing the second set of slots. Preferably the first set of slots is defined by a plurality of spaced apart first elongated elements or ribs. The slots of the first set may increase in width in a tapering manner towards their lower ends. Preferably the second set of slots is defined by a plurality of second elements or ribs. Preferably the filter basket includes an upper annular rim and the second elements or ribs extend downwardly from the upper rim. Preferably the filter basket includes an intermediate annular rib below the rim and the second elements or ribs extend between the annular rim and intermediate annular rib. Preferably the first elongated elements or ribs extend between the intermediate annular member and a base of the basket. The elongated elements or ribs preferably comprise hollow elongated ribs. The ribs are suitably filled with talc.

The openings in the base wall suitably comprise at least one set of openings arranged at spaced circumferential locations on a common radius. Most preferably, more than one set of openings are provided on different radiuses with one set of openings being located above the adjacent set of openings. Preferably the openings are elongated in the circumferential direction. Preferably the openings in each set are located at an equispaced location around the base wall. Preferably the axes of the openings extend substantially parallel to the longitudinal axis of the filter basket.

Preferably the base wall also includes a plurality of upstanding prongs. Preferably the prongs are arranged at a circumferential spacing around the base wall. Preferably the prongs in each set are located at an equispaced location around the base wall. Preferably at least some of the prongs are aligned with the openings and are arranged centrally thereof. The upstanding prongs serve to trapping hair and fibrous material as well as other objects which may pass into the filter basket.

The filter may also have an upstanding central post extending upwardly from the base wall. Preferably the post extends beyond an upper rim of the filter to facilitate grasping thereof and removal of the filter from a drain opening.

The present invention in a further preferred aspect provides a filter assembly including a filter of the above type, the filter assembly including a strainer adapted to be located in said floor drain, and wherein said filter is detachably secured to said strainer on the underside thereof and adapted to extend into said floor drain to filter liquid passing through said strainer.

Typically, the strainer is of a disc-like form and provided with a plurality of apertures or slots therein through which liquid can pass. Some solid materials such as hair however will also pass through the apertures or slots in the strainer into the drain however these in the main will be captured by the filter located beneath the strainer.

For attachment to the strainer, the upstanding post of the filter basket may comprise an attachment post and the strainer is releasably secured to the filter basket by a fastener engaged with the attachment post. The attachment post may be hollow at least at its upper end for engagement by the fastener. Suitably the attachment post is internally threaded and the fastener comprises an attachment screw passed through the strainer and threaded into the attachment post. The strainer is preferably centrally apertured to receive the attachment screw.

The above described arrangement is suitably for retrofitting to an existing strainer which may be removed from a drain opening, centrally drilled to enable a fastener to be passed therethrough to secure the filter to the strainer and reinserted into the drain opening.

In an alternative arrangement suitable for installations into new buildings the filter is suitably frictionally engaged with the underside of the strainer. For this purpose, the strainer is preferably provided on its underside with an annular rib adapted for frictional engagement by the upper rim of the filter. For connection to a drain pipe, the filter assembly may include a coupling adapted to be connected to the drain pipe. The coupling suitably is of tubular configuration and has an internal diameter substantially the same as the outer diameter of a drain pipe to which the coupling is to be connected. Preferably the coupling has a shoulder at its upper end which defines a seat for the strainer. The shoulder is suitably surrounded by an annular rim and the strainer when seated on the shoulder is suitably flush with the annular rim. The coupling is typically installed so as to be substantially flush with a floor or base of the liquid container.

The filter of course may be attached to a strainer by any other form of attachment means such as screw fasteners, clips or other form of fastener.

### BRIEF DESCRIPTION OF THE DRAWINGS

In order that the invention may be more readily understood and put into practical effect, reference will now be made to the accompanying drawings which illustrate a preferred embodiment of the invention and wherein:—

FIG. 1 is a side view of a filter assembly according to a first embodiment of the invention;

FIGS. 2 and 3 are plan and side views of the filter of the filter assembly of FIG. 1;

FIG. 2A is an enlarged side view of the base of the filter;

FIGS. 4 and 5 are perspective views of a modified form of filter;

FIG. 6 illustrates a filter assembly according to a second embodiment of the invention;

FIG. 7 is an exploded view of the filter assembly of FIG. 6;

FIG. 7A is a sectional view of portion of the rim of the strainer showing its connection with the filter of the filter assembly of FIG. 6;

FIG. 8 illustrates the separated filter and strainer of the tiller assembly of FIG. 7;

FIG. 9 is a cut away view of the filter assembly of another embodiment of the invention incorporating a modified filter;

FIGS. 10 and 11 are plan and side views of an alternative filter according to another embodiment of the invention;

FIGS. 12, 12A and 12B are plan an side and bottom views of a filter assembly according to a further embodiment of the invention;

FIG. 13 is a cutaway view of a floor drain incorporating a pop-up drain plug for use with the filter assembly of FIG. 12; and

FIG. 14 is a cut away view of the floor drain of FIG. 13 with the filter assembly of FIG. 12 installed inside the floor drain.

### DETAILED DESCRIPTION OF THE DRAWINGS

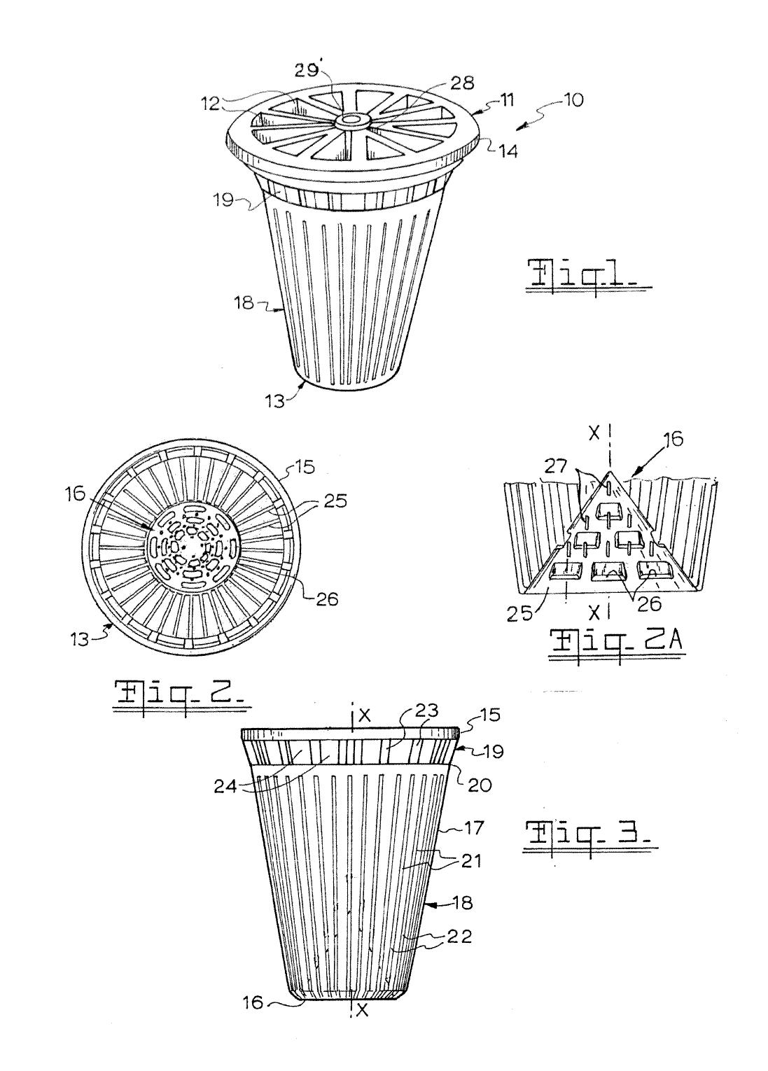

Referring to the drawings and firstly to FIGS. 1 to 3 there is illustrated a filter assembly for use in a combination with a waste or drain pipe according to an embodiment of the present invention. The filter assembly 10 includes a strainer 11 of conventional grating-like form being of a generally disc-like configuration and including a plurality of radially extending drain apertures or slots 12 therein and a filter 13 of basket-like form mounted to the underside of the strainer 11, the filter 13 having a central longitudinally extending axis X-X. The strainer 11 is typically received in a terminating pipe fitting or socket which is connected to a drain pipe and which is fitted within the floor or base to be drained and has an outer annular flange portion 14 which seats on a shoulder in the pipe fitting or socket so as to be substantially flush with the floor or base. Thus where the floor is a floor of concrete or the like, the pipe fitting or socket is embedded within the concrete floor. In the case of a basin, the pipe fitting or socket is secured to the base of the basin at the drain opening.

As shown more clearly in FIGS. 2, 2A and 3, the filter 13 comprises a cup-shaped body which is of a circular cross-section centered on the axis X-X and which has an upper annular rim 15, a base 16 of hollow conical form spaced from the rim 15 along the axis X-X and a frustoconical outer wall 17 around the axis X-X which extends between the rim 15 and base 16. The frustoconical wall 17 comprises a lower wall portion 18 extending upwardly from the base 16 and an upper wall portion 19 extending downwardly from the rim 15, the upper and lower wall portions 19 and 18 meeting at an annular rib 20.

The lower wall portion 18 is defined by a plurality of circumferentially spaced elongated ribs 21 defining elongated slots 22 therebetween extending between the base 16 and annular rib 19. The upper wall portion 19 is also defined by a plurality of circumferentially spaced ribs 23 extending between the rim 14 and annular rib 20 and defining enlarged slots 24 therebetween. The slots 24 are substantially larger in circumferential width than the slots 1. The slots 22 may also taper in width from the top towards their bottom so as to be of greater width at their bottoms to enhance drainage.

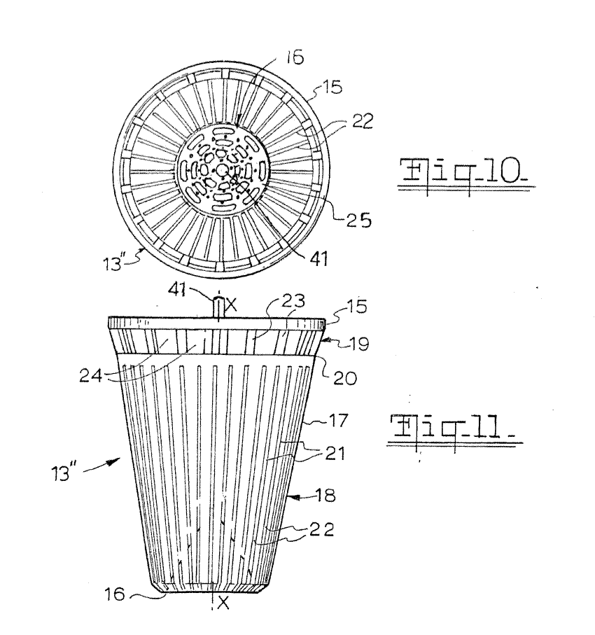

The base 16 of the filter 13 has a conical wall 25 (shown also in FIG. 9) which extends upwardly from the lower end of the wall portion 18 to be located within the wall portion 18. The wall 25 is centered on the axis X-X and this is coaxial with the wall portion 18. The wall 25 is provided with a plurality of openings 26 therethrough which are arranged in sets at different levels along the base wall 25 relative to the X-X axis of the filter 13. The openings 26 extend in a circumferential direction and are of a generally elongated slot-like configuration in the circumferential direction. Preferably the central axes of the openings 26 extend substantially parallel to the X-X axis to form flutes on the underside of the conical wall 25.

The base 16 is additionally provided with a plurality of upwardly directed prongs or projections 27 which extend above the base wall 25 and substantially parallel to the axis X-X. The prongs 27 are also arranged in sets at different levels on the base in circumferentially extending rows. Typically the prongs 27 extend approximately 1 mm from their connection to the upper surface of the wall 25.

The filter 13 is preferably integrally formed of plastics such as polypropylene and is injection moulded. The ribs 21 and 23 may be hollow and filled with talc.

In use and for installation of a filter 13 in an installed floor drain having an existing strainer 11, the strainer 11 is initially removed from the drain and a filter 13 is then located in the drain to be supported by the rim 15 seating on a shoulder in the drain. The strainer 11 can then be relocated in its normal position on a shoulder in the drain end fitting with the filter 13 extending into the drain pipe.

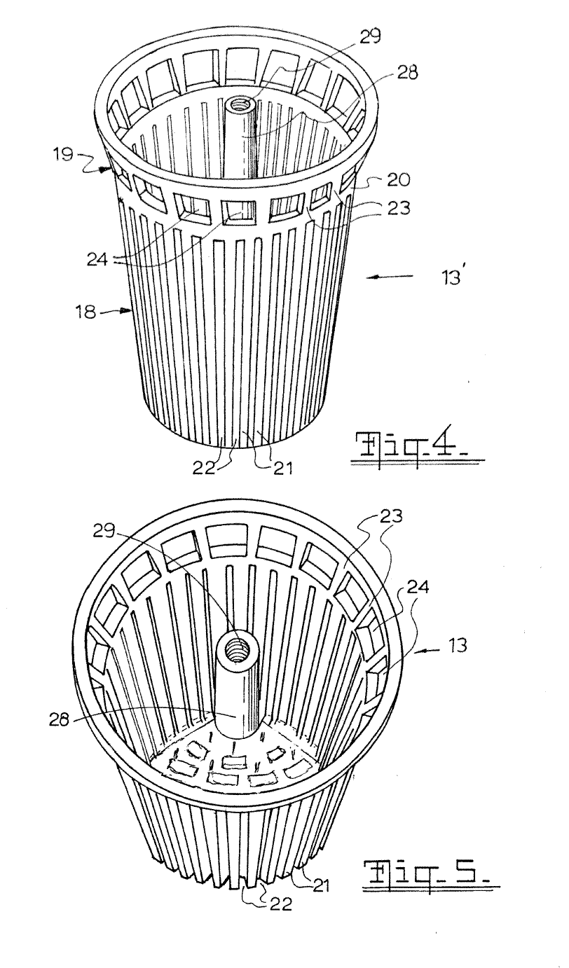

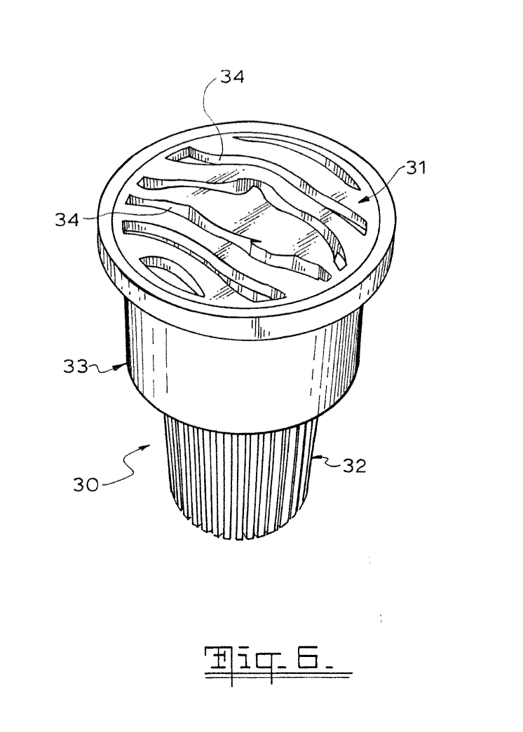

The filter 13′ as shown in the embodiment of FIGS. 4 and 5 additionally may include a central post 28 formed integrally with and extending upwardly from the base wall 25 and extending along the axis X-X, the upper end of the post 28 being hollow and internally threaded as at 29.

In this case for installation of a filter 13′ of the type shown in FIGS. 4 and 5 in an installed floor drain having an existing strainer 11, the strainer 11 is initially removed from the drain and a central aperture 29′ formed therethrough in such as by drilling. A filter 13 is then positioned relative to the strainer 11 such that the central aperture 29′ is aligned with the post 28. The strainer 11 can then be secured to the filter 13 by means of a screw typically a stainless steel screw which is screwed through the aperture 29′ in the strainer 11 into the threaded post 28. The strainer 11 with attached filter 13 may then be reinserted into the drain, the strainer 11 locating in its normal position on a shoulder in the drain end fitting and the filter 13 extending into the drain pipe.

The filter assembly 10 will function in the manner of a normal strainer 11 to drain water or other liquids except that solid materials such as hair or skin passing through the strainer 11 will be captured in the filter 13 (or 13′) and thus be prevented from entering the plumbing of the dwelling or from passing into the main drainage system. The strainer 11 with attached filter 13 (or 13′) may be removed at regular intervals to enable cleaning of the filter 13 (or 13′) and/or cleaning and/or replacement. Should the slots 22 in the lower portion of the filter 13 (or 13′) become blocked or partially blocked, the upper enlarged slots 23 will allow drainage of water to avoid flooding. The filter 13 (or 13′) is preferably made of a size to fit different size floor drains but may be made in different sizes for differed sized floor drains. If desired also a crystalline antiseptic or antibacterial material may be added to the filter 13 (or 13′) so that water passing through the filter 13 (or 13′) is exposed to such material.

Referring now to FIGS. 6 to 8 there is illustrated a further embodiment of filter assembly according to the present invention including a strainer or grating 31, a filter 32 and a drain coupling 33 for coupling the filter assembly 30 to a drain pipe. The strainer 31 is of disc-like configuration including slots or openings 34 therethrough which may be or any configuration for the passage of water through the strainer 31. The underside of the strainer 31 includes an annular rib 35 of a rectangular cross section located radially inwardly from the outer periphery of the strainer 31. The filter assembly 32 of FIG. 9 is also similar to that of FIG. 6 except that the coupling 33 is an externally threaded waste and may be plugged by a plug 40 when the strainer 31 is removed.

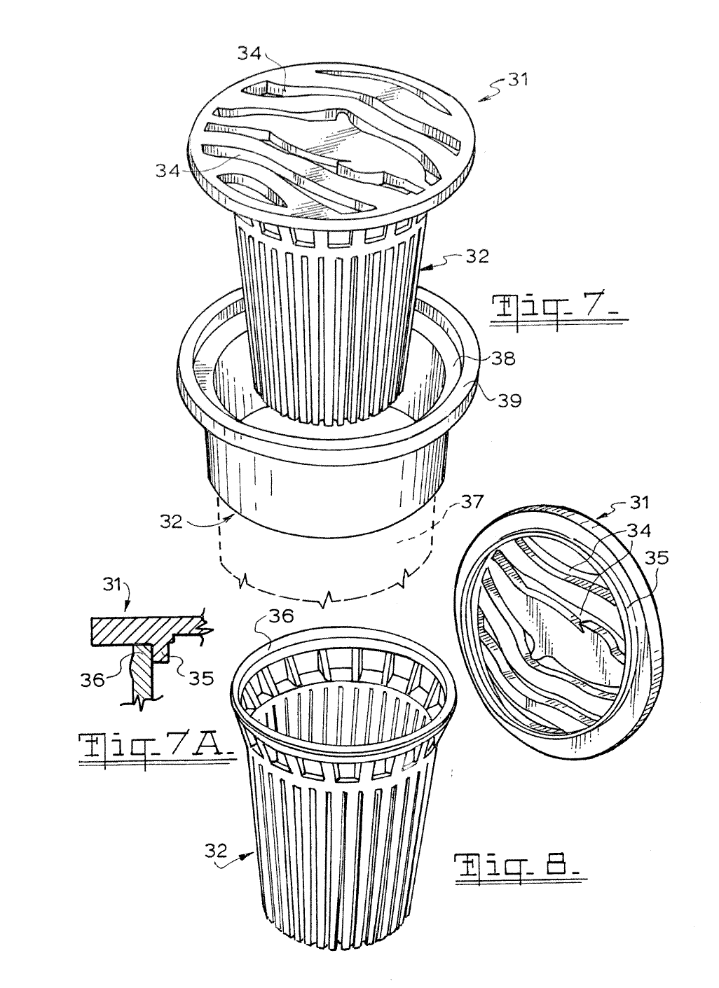

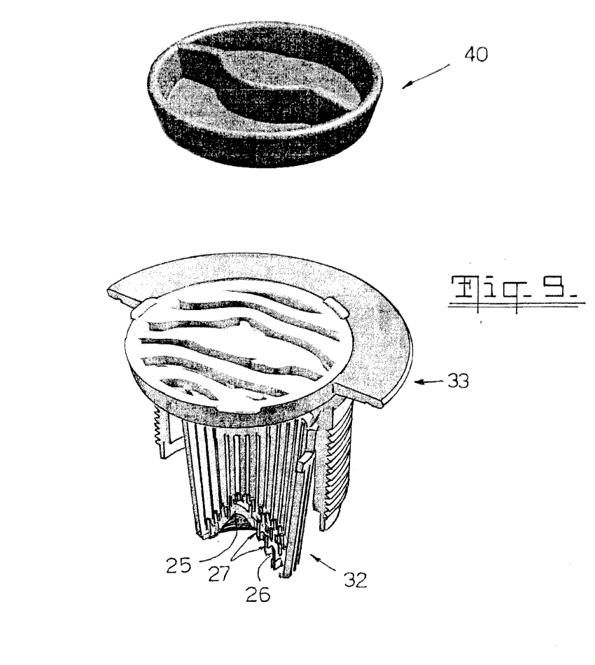

The filter 32 is of similar construction to the filter 13 of FIGS. 2 to 5 however with the central post 26 excluded. The base of the filter 312 is of the same configuration as the base of the filter 13 and accordingly like components have been given like numerals. Thus the filter 32 has a conical base wall 25, openings 26 therethrough and upstanding prongs 27. The annular upper rim 36 of the basket 32 is slightly internally flared outwardly on its inner side as is apparent in FIGS. 7A and 8 and has an internal diameter similar to the outer diameter of the rib 35. The filter 32 can thus be pushed onto the underside of the strainer 31 with the frictional engagement between the rim 36 and rib 35 securing the filter 32 to the strainer 31.

The coupling 33 is of generally tubular configuration and has in inner diameter such that it may be connected to a drain pipe 37 (shown in dotted outline in FIG. 7) using suitably adhesives. The upper end of the coupling 33 has an outwardly stepped shoulder 38 surrounded by a rim 39, the latter having an internal diameter substantially the same as the external diameter of the strainer 31.

In use, the coupling 33 is installed in a floor by being connected to a drain pipe 37 and such that the upper edge of the rim 39 is substantially flush with the upper surface of the floor, floor tiles or the like. The strainer 31 with frictionally attached filter 32 may then be inserted into the coupling 33 so that the strainer 31 seats on the shoulder 38 to be substantially flush with the upper edge of the rim 39.

As with the embodiment of FIGS. 1 to 5, water will pass through the strainer 31 and through the filter 32 and into the drain pipe 37. Foreign materials such as hair entering the basket 32 will not pass into the drain pipe 37 but be caught within the filter 32. The filter 32 will also sere to catch jewelry falling through the strainer 31. The upstanding prongs 27 serve to catch fibrous material such as hair and other objects which fall into the drain. The conical wall 25 of the filter provides an increased surface area for filtering whilst the openings 26 in the wall cause a vortex to be created on the underside of the wall 25 a backpressure to accelerate flow through the filter 32.

For cleaning purposes, the strainer 31 and attached filter 32 may be removed from the coupling 33 and the filter 32 detached from the strainer 31 if required for cleaning or for replacement.

The filter 13″ as shown in the embodiment of FIGS. 10 and 11 is in the same configuration as the filter 13 of FIGS. 1, 2, 2A and 3 but includes a central post 41 formed integrally with and extending upwardly from the base wall 25 and extending along the axis X-X. The post 41 extends above the upper rim 15 of the filter 13″ to enable it to be easily gripped and the filter 13″ lifted thereby from the drain or replaced into the drain.

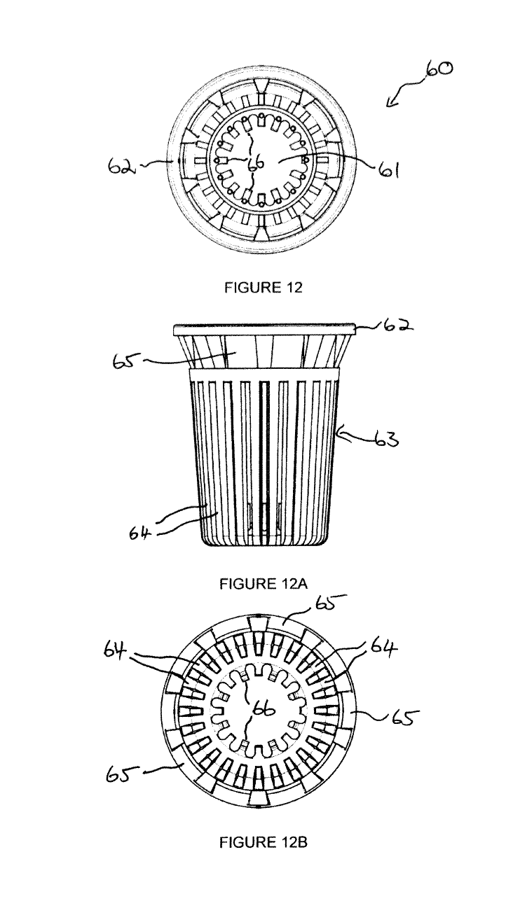

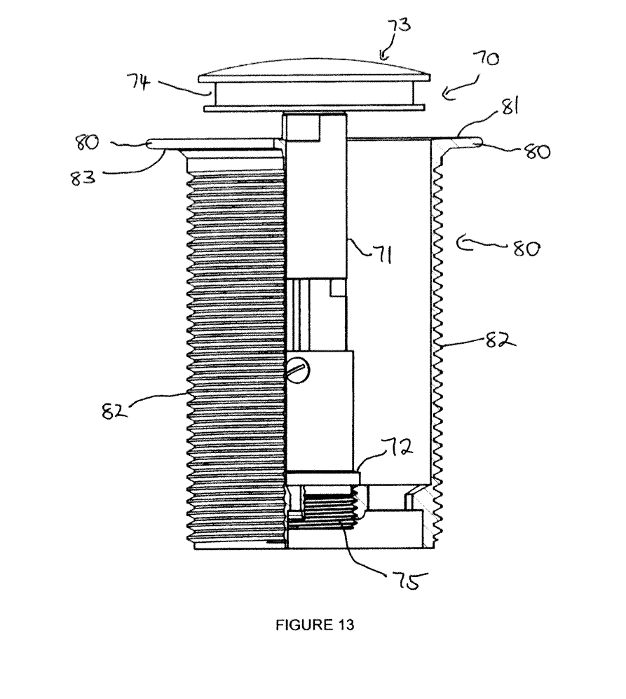

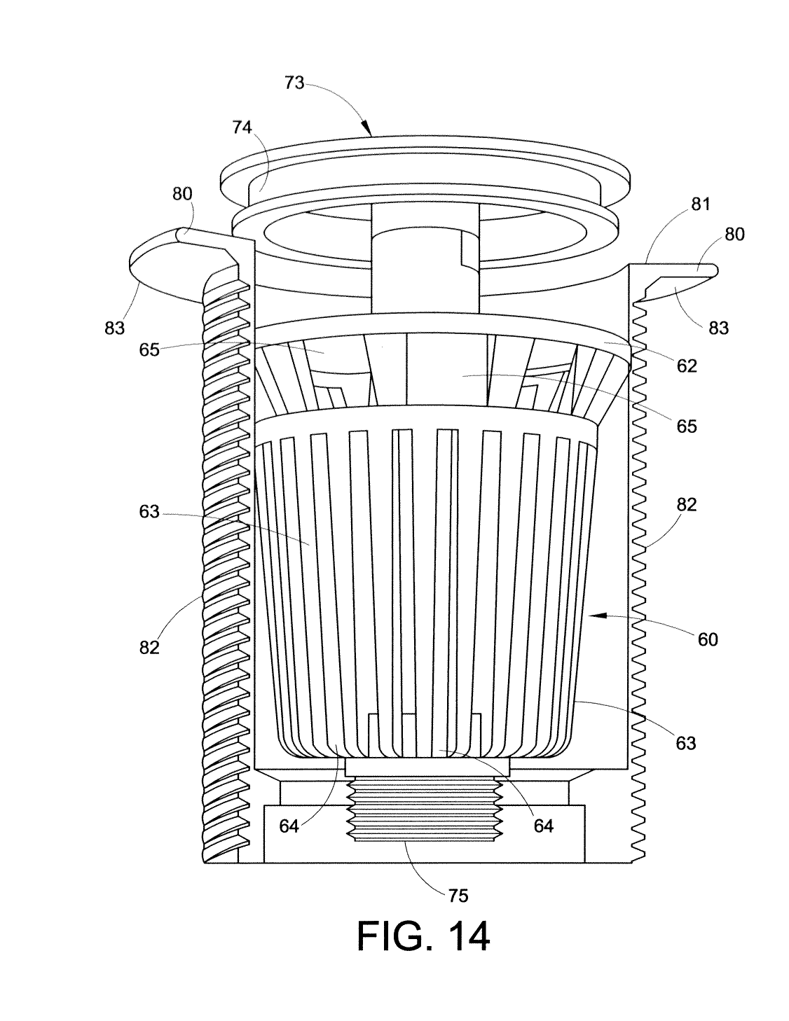

FIGS. 12, 12A and 12B show an alternative filter 60 used in conjunction with the pop-up floor drain assembly of FIGS. 13 and 14. The filter 60 is of similar construction to the filter 13 of FIGS. 2 to 5 however with the central post 26 excluded. Also, the base of the filter 60 has a central opening 61 through which the pop-up valve 70 is located. The pop-up valve 70 is screwed into the coupling 80 at or in close proximity to the base of the filter 60 and the base of the coupling 80.

The filter assembly 60 will function in the manner of a normal strainer to drain water or other liquids except that solid materials such as hair or skin passing through the gap between the cap 73 of the pop-up valve 70 and the rim 83 of the coupling 80 and will be captured in the filter 60 and thus be prevented from entering the plumbing of the dwelling or from passing into the main drainage system.

The pop-up valve 70 and the filter 60 may be removed at regular intervals to enable cleaning of the filter 60 and/or cleaning and/or replacement. Should the slots 64 in the lower portion of the filter 60 become blocked or partially blocked, the upper enlarged slots 65 will allow drainage of water to avoid flooding. The filter 60 is preferably made of a size to fit different size floor drains but may be made in different sizes for differed sized floor drains. If desired also a crystalline antiseptic or antibacterial material may be added to the filter 60 so that water passing through the filter 60 is exposed to such material.

The annular upper rim 62 of the basket 63 is slightly internally flared outwardly on its inner side. The filter 60 can thus be pushed onto the elongated plunger 71 of the pop-up valve 70 and the ribs 66 are located in contact with the flange 72 located at the lower end of the elongated plunger 71. As shown in FIG. 14 the upper rim 62 of the filter 60 sits a distance below the top 81 of the coupling 80. The distance which the filter 60 sits below the top 81 of the coupling 80 is substantially the same as the thickness of the cap 73 of the pop-up valve 70.

In this embodiment the strainer 11 is replaced by the pop-up valve 70. The pop-up valve is operated by pressing on the center of the cap 73 until it snaps closed, stopping any water from draining out of your floor drain. With another press, the valve pops open and allows the water to drain through the floor drain. An actuator means (not shown) is located within the elongated plunger 71 of the pop-up valve 70 in a section between the base or screw thread 75 and the cap 73 to move the pop-up valve 70 up and down within the floor drain.

The coupling 80 is of generally tubular configuration and has an outer screw thread 82 such that it may be connected to a drain pipe (not shown) using suitably adhesives. The upper end of the coupling 80 has a rim 83, the rim 83 having an internal diameter substantially the same as the external diameter of the cap 73 of the pop-up valve 70. The cap 73 has a recess 74 within which a seal is placed to seal the pop-up valve 70 to the coupling 80.

In use, the coupling 80 is installed in a floor by being connected to a drain pipe and such that the upper edge of the rim 83 is substantially flush with the upper surface of the floor, floor tiles or the like. The elongated plunger 71 with screw thread 75 is located within the screw thread at the bottom of the coupling 80. The filter 60 is then inserted into the opening of the coupling 80 and located on top of the flange 72 of the pop-up valve 70. The filter 60 can thus be pushed onto the upper side of the flange 72 of the pop-up valve 70 with the frictional engagement between the flange 72 and the ribs 66 securing the filter 60 to the pop-up valve 70. Finally the cap 73 of the pop-up valve is secured to the elongated plunger 71 by complementary screw thread in both the inside of the cap 73 and the outer end of the elongated plunger 71.

Whilst the filters are shown to have slots therein for passage of fluid therethrough, the slots alternatively may be replaced by apertures of any shape or size. Apertures may be provided in upper and lower sets corresponding to the slots in the upper and outer sets. Thus the apertures in the upper set may be of a greater cross sectional area than the apertures in the lower set. The filter and strainer may also be of various sizes to suit the drain size such as 50 mm, 80 mm and 100 mm.

The terms “comprising” or “comprises” as used throughout the specification are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as herein described.

The claims of the present invention are as follows:

1. A filter assembly for a floor drain, said filter comprising:
a hollow filter basket having a base wall and a side wall extending from said base wall, said side wall having a plurality of slots or openings through which water may pass, and said base wall being of a conical form and having a plurality of openings therein.

2. A filter assembly according to claim 1, wherein the slots or openings in the side wall comprise an upper set of slots or openings and a lower set of slots or openings, wherein the slots are slots which extend generally longitudinally of the filter basket.

3. A filter assembly according to claim 2, wherein the slots in the upper set of slots are of a greater cross sectional area or greater width than the slots in the lower set of slots, therefore if the lower set of slots tend to become blocked or partly blocked, liquid can still flow through the tilter basket by passing through the slots of the upper set.

4. A filter assembly according to claim 3, wherein the filter basket is of a generally cup shaped configuration, wherein the filter basket has a lower frustoconical outer wall portion containing the lower set of slots and an upper frustoconical outer wall portion containing the upper set of slots.

5. A filter assembly according to claim 4, wherein the lower set of slots is defined by a plurality of spaced apart first elongated elements or ribs and wherein the slots of the lower set decrease in width in a tapering manner towards their lower ends, and the upper set of slots is defined by a plurality of second elements or ribs.

6. A filter assembly according to claim 5, wherein the filter basket includes an upper annular rim and the second elements or ribs extend downwardly from the upper rim.

7. A filter assembly according to claim 6, further comprising an intermediate annular rib below the annular rim and the second elements or ribs extend between the annular rim and intermediate annular rib.

8. A filter assembly according to any one of claims 6, wherein the first elongated elements or ribs extend between the intermediate annular member and a base of the basket.

9. A filter assembly according to claim 1, wherein the openings in the base wall suitably comprise at least one set of openings arranged at spaced circumferential locations on a common radius, and preferably or optionally more than one set of openings are provided on different radiuses with one set of openings being located above the adjacent set of openings.

10. A filter assembly according to claim 9, wherein the openings are elongated in the circumferential direction, wherein the openings in each set are located at an equispaced location around the base wall, and the axes of the openings extend substantially parallel to the longitudinal axis of the filter basket.

11. A filter assembly according to claim 10, wherein the base wall also includes a plurality of upstanding prongs, wherein the prongs are arranged at a circumferential spacing around the base wall, the prongs in each set are located at an equispaced location around the base wall, and at least some of the prongs are aligned with the openings and are arranged centrally thereof, wherein the upstanding prongs serve to trap hair and fibrous material as well as other objects which may pass into the filter basket.

12. A filter assembly according to claim 1, wherein the filter further includes an upstanding central post extending upwardly from the base wall, and wherein the post extends beyond an upper rim of the filter to facilitate grasping thereof and removal of the filter from a drain opening.

13. A filter assembly according to claim 1, the filter assembly further including
a strainer adapted to be located in said floor drain; and
wherein said filter is detachably secured to said strainer on the underside thereof and adapted to extend into said floor drain to filter liquid passing through said strainer.

14. A filter assembly according to claim 13, wherein the strainer is of a disc-like form and provided with a plurality of apertures or slots therein through which liquid can pass.

15. A filter assembly according to claim 14, wherein the strainer is attached to the filter assembly by an upstanding post of the filter basket, wherein the attachment post and the strainer are releasably secured to the filter basket by a fastener engaged with the attachment post.

16. A filter assembly according to claim 15, wherein the attachment post is hollow at least at its upper end for engagement by the fastener, and preferably or optionally the attachment post is internally threaded and the fastener comprises an attachment screw passed through the strainer and threaded into the attachment post, and the strainer is preferably centrally apertured to receive the attachment screw.

17. A method for installation of a filter assembly into a new buildings, the filter assembly comprising a filter suitably frictionally engaged with the underside of a strainer, the strainer on its underside comprising an annular rib adapted for frictional engagement by an upper rim of the filter;
connecting the filter assembly to a drain pipe using a suitable coupling adapted to be connected to the drain pipe, the coupling is of tubular configuration and has an internal diameter substantially the same as the outer diameter of a drain pipe to which the coupling is to be connected, wherein the coupling has a shoulder at its upper end which defines a seat for the strainer, the shoulder is suitably surrounded by an annular rim and the strainer when seated on the shoulder is suitably flush with the annular rim, and
wherein the coupling is installed so as to be substantially flush with a floor or base of a liquid container.

18. A method of installation of a filter assembly according to claim 17, wherein the filter is attached to the strainer by any other form of attachment means such as screw fasteners, clips or other form of fastener or the like.
